(19) United States
(12) Patent Application Publication
(10) Pub. No.: US 2026/0212722 A1
(43) Pub. Date: Jul. 23, 2026

(54) Alignment and Discrimination Module of Medium Deposit Device

(71) Applicant: HYOSUNG TNS INC., Seoul (KR)

(72) Inventors: Jun Young KIM, Seoul (KR); Young Chul LEE, Gyeonggi-do (KR); Hyun Sik WOO, Seoul (KR); Da Hye SHIN, Incheon (KR); Jin You LIM, Gyeonggi-do (KR); Yoon Kil BAEK, Seoul (KR)

(21) Appl. No.: 19/140,534

(22) PCT Filed: Nov. 16, 2023
(86) PCT No.: PCT/KR2023/018441

§ 371 Date: Jun. 18, 2025

(30) Foreign Application Priority Data
Dec. 29, 2022 (KR) 10-2022-0188702
Dec. 29, 2022 (KR) 10-2022-0188703

(51) Int. Cl. G07D 11/17; G07D 7/04; G07D 7/12; G07D 11/22; G07D 11/50

(52) U.S. Cl. CPC G07D 11/17; G07D 7/04; G07D 7/12; G07D 11/22; G07D 11/50

(57) ABSTRACT

One embodiment of an alignment and discrimination module of a medium deposit device comprises an alignment unit which performs alignment correction so that a medium being conveyed is aligned. The alignment unit includes a pair of a first correction roller and a second correction roller that are inclined toward one side with respect to the medium conveyance direction so as to face a reference surface on one side of a medium conveyance surface in order to perform skew correction so that the medium being conveyed is parallel to the conveyance direction and at the same time perform shift correction so that one end of the medium is aligned with the reference surface.

### TECHNICAL FIELD

The present invention relates to an alignment and discrimination module of a medium deposit device, and more particularly, to an alignment and discrimination module of a medium deposit device that have a structure in which an alignment unit and a discrimination unit are integrated and can rapidly and accurately perform skew correction and shift correction of a medium being conveyed.

### BACKGROUND ART

Conventional financial automation devices are devices developed to provide most financial services, except for consulting services, rapidly and conveniently without time constraints in relation to financial services, and include cash dispenser units (CDUs), bill recycling machines (BRMs), cash and cash and check in modules (CCIMs) that can simultaneously deposit and reject multiple sheets of media such as cash and checks in bundle units, etc.

Conventional CCIMs include a bundle module for inserting and receiving media in bundle units, a separation unit for separating the media inserted into the bundle module into individual sheets, an alignment unit for aligning a medium that is inclined to one side among the media that have passed through the separation unit so that the medium is positioned parallel to a conveyance direction, a discrimination unit for discriminating information and authenticity of a deposit medium conveyed after passing through the alignment module, a print module for printing information required for a deposited check, a cassette unit in which a medium that have been discriminated as a normal medium in the discrimination unit among media to be deposited is stored, and a reject module in which a media that have been discriminated as rejectable in the discrimination unit among the media to be deposited is stored.

In this way, a conventional medium deposit device (Korean Patent Registration No. 10-2144393) has a structure in which an alignment unit and a discrimination unit are separated, which causes a problem that the alignment unit and the discrimination unit occupy a lot of space and the structure of the device becomes complicated.

A conventional medium deposit device (Korean Patent Registration No. 10-1581725) has a structure in which a medium is aligned by being rotated in an alignment module of a cylindrical structure and shifted slightly to one side by the action of a spring. However, such an alignment structure has a limitation in that an alignment speed of the medium is slow and alignment is difficult to achieve accurately.

Meanwhile, a medium deposit device is generally provided with a discrimination unit for acquiring an image of a medium and determining the type and authenticity of the medium, and is provided with a medium alignment device for performing skew correction to correct an inclined angle of the medium so that the medium being conveyed is aligned in a correct position for accurate image acquisition in the discrimination unit and performing shift correction to move the medium in a direction orthogonal to a direction of travel of the medium so that the medium is aligned with a reference surface.

In the conventional medium deposit devices, skew correction and shift correction of media were performed step by step, which resulted in problems such as slow alignment speed and low alignment accuracy.

Further, in the conventional medium deposit devices, when skew correction and shift correction of a medium are performed, there was a problem in that when a front end of the medium is conveyed toward a sidewall of a medium conveyance surface and collides with the sidewall, the angle of the medium was turned in a direction of a reaction force due to a force applied to the sidewall of the conveyance surface by the medium and a moment generated by the reaction force applied to the sidewall of the conveyance surface by the medium, a side surface of the medium was not aligned with an alignment reference surface, which is a position where the side surface of the medium comes into contact with the sidewall of the medium conveyance surface, and thus alignment correction of the medium was not performed properly. Related art related to the media alignment device is disclosed in Korean Patent Registration No. 10-1453674.

### DETAILED DESCRIPTION OF INVENTION

### Technical Problem

The present invention is directed to solving the above-described problems, and providing an alignment and discrimination module of a medium deposit device in which a structure of the medium deposit device is simplified and skew correction and shift correction of a medium are simultaneously performed to shorten an alignment time of the medium and improve the accuracy of the alignment.

The present invention is also directed to enabling skew correction and shift correction of a medium to be accurately and rapidly performed and enabling a medium to be aligned in a correct position even when a reaction force is applied to the medium when the skew correction and shift correction of the medium is performed.

### Technical Solution

According to an aspect of the present invention, there is provided an alignment and discrimination module of a medium deposit device, comprising an alignment unit configured to perform alignment correction so that a medium being conveyed is aligned, wherein the alignment unit includes a pair of a first correction roller and a second correction roller that are inclined toward one side with respect to a conveyance direction of the medium so as to face a reference surface on one side of a medium conveyance surface in order to perform skew correction so that the medium being conveyed is parallel to the conveyance direction, and at the same time, perform shift correction so that one end of the medium is aligned with the reference surface.

The first correction roller is connected to a main conveyance drive system that drives all of a plurality of conveyance rollers arranged at a predetermined interval in the conveyance direction of the medium for conveyance of the medium and is rotatably driven, and the second correction roller is rotatably driven by a correction conveyance drive system.

The alignment and discrimination module further comprising: a plurality of skew sensors configured to detect whether the medium being conveyed is skewed; a plurality of shift sensors configured to detect whether the medium being conveyed is shifted; and a control unit configured to control skew correction and shift correction of the medium to be performed by determining a degree of skew of the medium on the basis of data detected by the plurality of skew sensors and determining a degree of shift of the medium on the basis of data detected by the plurality of shift sensors.

The control unit controls a driving speed of the correction conveyance drive system in a state in which the driving of the main conveyance drive system is stopped so that the medium being conveyed is in an aligned state when skew correction and shift correction of the medium are required.

The control unit individually controls a driving speed of the main conveyance drive system and a driving speed of the correction conveyance drive system so that the medium being conveyed is in an aligned state when skew correction and shift correction of the medium are required.

Each of the plurality of conveyance rollers is composed of a pair of a driving conveyance roller and an idle conveyance roller that are arranged to be in contact with each other up and down and are rotatably driven to convey the medium, each of the first correction roller and the second correction roller is composed of a pair of a driving correction roller and an idle correction roller that are arranged to be in contact with each other up and down and are rotatably driven to align and correct the medium, and the alignment and discrimination module includes: a conveyance solenoid that causes the pair of the driving conveyance roller and the idle conveyance roller to be in contact with each other during the conveyance of the medium to support and convey the medium, and cause the pair of the driving conveyance roller and the idle conveyance roller to be separated from each other during the alignment correction of the medium so that the conveyance of the medium by the pair of the driving conveyance roller and the idle conveyance roller is stopped; and a correction solenoid that causes the alignment correction of the medium not to be performed from being performed by causing the pair of the driving correction roller and the idle correction roller to be separated from each other during the conveyance of the medium, and causes the pair of the driving correction roller and the idle correction roller to be in contact with each other during the alignment correction of the medium so that the alignment correction of the medium is performed.

The conveyance solenoid is configured to transmit power to a conveyance solenoid rod that is drawn out or drawn in according to whether power is supplied, a first shaft connected to the conveyance solenoid rod, a conveyance link member that has an upper portion through which the first shaft passes and is connected, supports the conveyance roller, and is rotated in conjunction with the movement of the conveyance solenoid rod, a second shaft that passes through a lower portion of the conveyance link member and forms a center of rotation of the conveyance link member, and a moving member that supports each of the plurality of conveyance rollers, is connected to one side portion of the plurality of conveyance link members arranged to be spaced apart from each other in the conveyance direction of the medium, and is moved forward and rearward to simultaneously rotate the plurality of conveyance link members.

The correction solenoid is configured to transmit power to a correction solenoid rod that is drawn out or drawn in according to whether power is supplied, a third shaft connected to the correction solenoid rod, a first correction link member that has an upper portion through which the third shaft passes and is connected, and is moved forward and rearward in conjunction with the movement of the correction solenoid rod, a fourth shaft that passes through and is connected to a lower portion of the first correction link member, and a second correction link member through which the fourth shaft passes and is connected, and which comes into contact with a lower portion of the first correction link member, is rotated around the fourth shaft as the center of rotation in conjunction with the forward and backward movement of the first correction link member, and supports the first correction roller and the second correction roller.

A first inclined surface is formed on a lower surface of the first correction link member, a second inclined surface is formed on an upper surface of the second correction link member to be in contact with the first inclined surface, and the second correction link member is rotated by a force exerted by the first inclined surface on the second inclined surface in conjunction with the movement of the correction solenoid rod.

The alignment and discrimination module further comprising a discrimination unit configured to discriminate a type and authenticity of the medium, wherein the alignment unit and the discrimination unit are formed as an integrated structure.

The discrimination unit includes at least one sensor among an image sensor for acquiring an image of the medium and discriminating the type of the medium, a magnetic sensor for detecting a magnetic component within the medium and discriminating the authenticity of the medium, and an ultraviolet sensor for detecting an ultraviolet substance within the medium and discriminating the authenticity of the medium.

The alignment and discrimination module further comprising a discrimination unit configured to discriminate a type and authenticity of the medium; and an encoder sensor configured to measure a conveyance speed of the medium by driving the main conveyance drive system and also measures an image scan cycle of the discrimination unit.

The plurality of skew sensors are provided as at least three skew sensors at positions spaced apart from each other in a direction orthogonal to the conveyance direction of the medium on a front side of the first correction roller and the second correction roller.

When determining whether the medium is skewed, data detected by the plurality of skew sensors is transmitted to the control unit, and the control unit calculates the degree of skew of the medium on the basis of only pieces of data having an arithmetic sequence relationship among the data detected by the plurality of skew sensors.

The plurality of skew sensors are provided as four or more skew sensors, wherein the control unit calculates the degree of skew of the medium on the basis of two pieces of data having a largest detection time difference among the data having an arithmetic sequence relationship detected by the plurality of skew sensors.

The control unit determines the degree of skew of the medium on the basis of a distance between the skew sensors that have detected the two pieces of data, a difference between times at which the skew sensors that have detected the two pieces of data each detected the medium, and a conveyance speed of the medium.

The plurality of shift sensors include a first shift sensor and a second shift sensor which are provided at positions close to the reference surface and spaced apart from each other in the conveyance direction of the medium, and a third shift sensor and a fourth shift sensor which are provided at positions to be spaced in the conveyance direction of the medium at a position further than the distance at which the first shift sensor and the second shift sensor are spaced apart from the reference surface.

When determining whether the medium is shifted, data detected by the plurality of shift sensors is transmitted to the control unit, and the control unit controls shift correction to be performed by determining the degree of shift of the medium being conveyed on the basis of signals detected by the plurality of shift sensors and differentially setting a time at which the shift correction is performed according to the degree of shift.

When the medium is detected by only any one of the third shift sensor and the fourth shift, the control unit controls skew correction to be performed until the medium is detected by the remaining one of the third shift sensor and the fourth shift sensor and then shift correction to be performed for a first set period of time.

When the medium is detected by the first shift sensor and the fourth shift sensor among the plurality of shift sensors, the control unit controls skew correction to be performed until the medium is detected by the third shift sensor and then shift correction to be performed for a first set period of time.

When the medium is detected by the third shift sensor and the fourth shift sensor among the plurality of shift sensors or when the medium is detected by the first shift sensor, the third shift sensor, and the fourth shift sensor, the control unit controls skew correction to be performed for a second set period of time and then shift correction to be performed for a third set period of time.

When the medium is detected by the first shift sensor, the second shift sensor, and the fourth shift sensor among the plurality of shift sensors, when the medium is detected by the second shift sensor, the third shift sensor, and the fourth shift sensor, or when the medium is detected by all of the plurality of shift sensors, the control unit controls the medium to be conveyed without skew correction and shift correction.

The alignment and discrimination module further comprising a control unit configured to control a rotation timing of the pair of the first correction roller and the second correction roller so that an edge portion of a front end of the medium comes into contact with one sidewall of the medium conveyance surface at a rear position of a reference point, on the basis of the reference point where a direction of a force applied to the medium by the pair of the first correction roller and the second correction roller and a direction of a force applied to the medium from the one sidewall of the medium conveyance surface that comes into contact with the front end of the medium are identical when performing skew correction and shift correction of the medium.

An area between two points and where an imaginary extension line extending from the pair of the first correction roller and the second correction roller toward the one sidewall of the medium conveyance surface meet the one sidewall of the medium conveyance surface is set as the reference point.

When the skew correction is performed in a state in which an edge portion of one side of the front end of the medium is skewed closer to the reference surface than an edge portion of one side of a rear end of the medium is, the control unit controls the rotational drive of the pair of the first correction roller and the second correction roller so that the edge portion of the rear end of the medium first comes into contact with the one sidewall of the medium conveyance surface by overcorrection more than the skew correction amount that makes one end of the medium be parallel to the reference surface.

### Advantageous Effects

According to an alignment and discrimination module of a medium deposit device according to the present invention, an alignment unit and a discrimination unit can be configured as an integrated module so that a structure of the device can be simplified and skew correction and shift correction can be simultaneously performed, and thus the alignment operation of the medium can be rapidly performed.

Further, by enabling a first correction roller of a pair of correction rollers to be driven in conjunction with a main conveyance drive system and a second correction roller to be driven by a correction conveyance drive system provided separately from the main conveyance drive system, a driving structure of the correction rollers can be simplified.

Further, by providing a pair of correction rollers arranged to be inclined to one side with respect to a conveyance direction of the medium, skew correction and shift correction of the medium can be performed simultaneously and rapidly.

Further, by providing a conveyance solenoid that causes a conveyance roller to be supported during the conveyance of the medium and causes the conveyance roller to be separated during the correction of the medium and providing a correction solenoid that causes a correction roller to be separated during the conveyance of the medium and causes the correction roller to be in contact therewith during the correction of the medium, the accuracy of the skew correction and shift correction of the medium can be increased.

Further, by using an encoder sensor for measuring a conveyance path speed and an encoder sensor for measuring an image scan cycle to be shared as a single encoder sensor, the functions of the respective encoder sensors can be integrated and the structures of the encoder sensors can be simplified.

Further, by accurately determining a skew state and shift state of a medium and simultaneously performing skew correction and shift correction of the medium according to the determined skew state and shift state of the medium, an alignment time of the medium can be shortened and the accuracy of the alignment can be improved.

Further, by optimizing the arrangement of a plurality of skew sensors for detecting a skew state of a medium and a plurality of shift sensors for detecting a shift state of the medium, accurately determining a skew angle of the medium and the degree of shift of the medium on the basis of signals detected by these sensors, and controlling a driving speed and time of a correction roller, the medium can be aligned to a correct position.

Further, by providing a first correction roller of a pair of correction rollers to be driven in conjunction with a main conveyance drive system and a second correction roller to be driven by a correction conveyance drive system provided separately from the main conveyance drive system so that rotation speeds of the first and second correction rollers are individually controlled, a rotation angle of the medium can be controlled in a direction of a fast rotation speed, and thus the skew correction of the medium can be accurately controlled.

Further, by controlling a position at which a front end of the medium first comes into contact with a sidewall of a medium conveyance surface when skew and shift correction of the medium are performed, the medium can be aligned to a correct position on an alignment reference surface even when a reaction force is applied to the medium.

Further, by controlling a rear end of the medium to first come into contact with the sidewall of the medium conveyance surface when the skew and shift correction of the medium are performed, the medium can be aligned to a correct position on the alignment reference surface even when a reaction force is applied to the medium.

### DESCRIPTION OF DRAWINGS

FIG. 1 is a configuration diagram of a medium deposit device according to the present invention.

FIG. 2 is a perspective view of an alignment and discrimination module of the medium deposit device according to the present invention.

FIG. 3 is a plan view of FIG. 2.

FIG. 4 is a bottom view of FIG. 2.

FIGS. 5 and 6 are diagrams illustrating a process in which skew and shift alignment of a medium are performed in the alignment and discrimination module of the medium deposit device according to the present invention.

FIG. 7 is a control block diagram of the alignment and discrimination module of the medium deposit device according to the present invention.

FIG. 8 is a plan view illustrating a power transmission structure of a main conveyance drive system and a correction conveyance drive system of the alignment and discrimination module of the medium deposit device according to the present invention.

FIGS. 9 and 10 are perspective views illustrating a conveyance solenoid and a power transmission structure connected thereto that are provided in the alignment and discrimination module of the medium deposit device according to the present invention from different directions.

FIG. 11 is an operational state diagram of a conveyance solenoid and a power transmission structure connected thereto that are provided in the alignment and discrimination module of the medium deposit device according to the present invention.

FIG. 12 is a perspective view illustrating a correction solenoid and a power transmission structure connected thereto that are provided in the alignment and discrimination module of the medium deposit device according to the present invention.

FIG. 13 is an operational state diagram of a correction solenoid and a power transmission structure connected thereto that are provided in the alignment and discrimination module of the medium deposit device according to the present invention.

FIG. 14 is a diagram illustrating an arrangement structure of sensors for detecting a skew and shift state of a medium in the medium alignment device according to the present invention.

FIGS. 15 and 16 are diagrams illustrating a process of performing skew and shift correction of a medium in the medium alignment device according to the present invention.

FIGS. 17 and 18 are exemplary diagrams for describing a skew correction method of a medium according to a conveyance state of the medium in the medium alignment device according to the present invention.

FIGS. 19 to 23 are exemplary diagrams for describing a shift correction method of a medium according to a conveyance state of the medium in the medium alignment device according to the present invention.

FIG. 24 is a diagram illustrating a case in which shift correction of a medium according to a conveyance state of the medium is unnecessary in the medium alignment device according to the present invention.

FIG. 25 is a diagram for describing a problem in a case in which a front end of a skew medium comes into contact with one sidewall of the medium conveyance surface in front of a reference point in the medium alignment device according to the present invention.

FIG. 26 is a diagram for describing a method for controlling the front end of the skew medium to come into contact with one sidewall of the medium conveyance surface in front of the reference point in a medium alignment device according to the present invention.

FIG. 27 is a diagram for describing a method for controlling a rear end of the skew medium to come into contact with one sidewall of the medium conveyance surface in front of the reference point in the medium alignment device according to the present invention.

### REFERENCE NUMERALS

1: medium deposit device 10: input unit
20: bundle module 30: alignment and discrimination module
30a: alignment unit (medium alignment device) 30b: discrimination unit
31: conveyance surface 32: sidewall of conveyance surface
L: reference surface 40: temporary storage unit
50: reject unit 60: printing unit
70: medium storage unit 80: retract unit
100: main conveyance drive system 101: main conveyance motor
200: correction conveyance drive system 201: correction conveyance motor
300: conveyance solenoid 310: conveyance solenoid rod
320: first shaft 330: conveyance link member
340: second shaft 350: forward and rearward moving member
360: first elastic member 370: second elastic member
400: correction solenoid 410: correction solenoid rod
420: third shaft 430: first correction link member
440: second correction link member 450: fourth shaft
460: third elastic member 470: fourth elastic member
510: inlet roller 520, 520a, 530, 530a, 540, 540a: conveyance rollers
550, 550a, 560, 560a: correction rollers 610, 611, 612: alignment inlet sensors
620, 621, 622, 623, 624: skew sensors 630, 631, 632, 633, 634: shift sensors
640, 641, 642: discrimination inlet sensors 650: encoder sensor
700: control unit 810: image sensor
820: magnetic sensor 830: ultraviolet sensor

### MODES OF THE INVENTION

Hereinafter, a configuration and operation of an exemplary embodiment of the present invention will be described in detail with reference to the accompanying drawings.

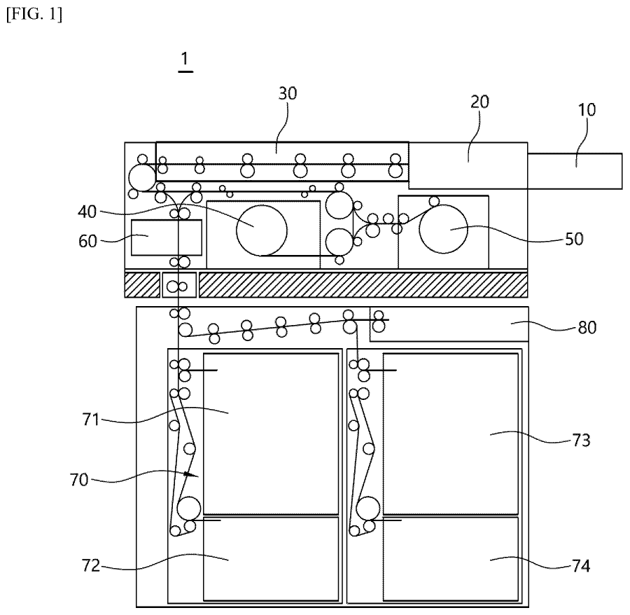

Referring to FIG. 1, a medium deposit device 1 to which the present invention is applied includes an input unit 10 into which cash, checks, or the like (hereinafter collectively referred to as a “medium”) are input in bundle units, a bundle module 20 that conveys the bundle units of media input into the input unit 10 and separates the bundle units of media into individual sheets, an alignment and discrimination module 30 that performs alignment correction so that a medium separated into individual sheets and conveyed is aligned and also discriminates the type and state of the medium, a temporary storage unit 40 in which the medium discriminated as a normal medium in the alignment and discrimination module 30 are temporarily stored, a reject unit 50 in which the medium discriminated as rejectable in the alignment and discrimination module 30 is stored, a printing unit 60 that prints financial information on checks, and a medium storage unit 70 that is composed of a plurality of cassettes 71, 72, 73, and 74 which separate the medium into cash and checks and store the separated cash and checks.

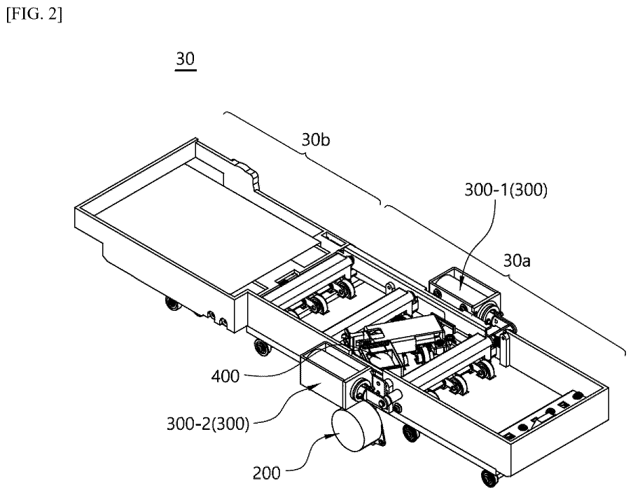

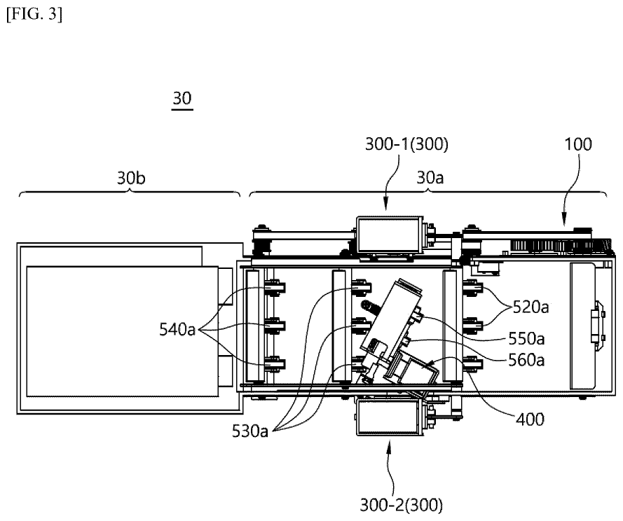

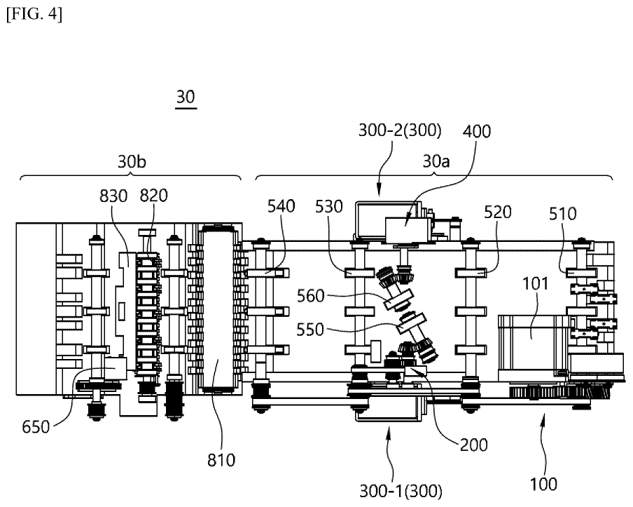

Hereinafter, a configuration of the alignment and discrimination module 30 of the medium deposit device 1 of the present invention will be described with reference to FIGS. 2 to 7.

The alignment and discrimination module 30 of the present invention is configured to have a structure in which an alignment unit 30a provided in a front portion thereof with respect to a conveyance direction of a medium and a discrimination unit 30b provided behind the alignment unit 30a are integrated.

The alignment unit 30a is a component for aligning a medium that is separated into individual sheets and conveyed while passing through the bundle module 20 in a state in which the medium may be discriminated by image acquisition or the like in the discrimination unit 30b, and is a component for performing alignment correction including skew correction and shift correction of the medium. Hereinafter, the alignment correction is used to mean both the skew correction and the shift correction.

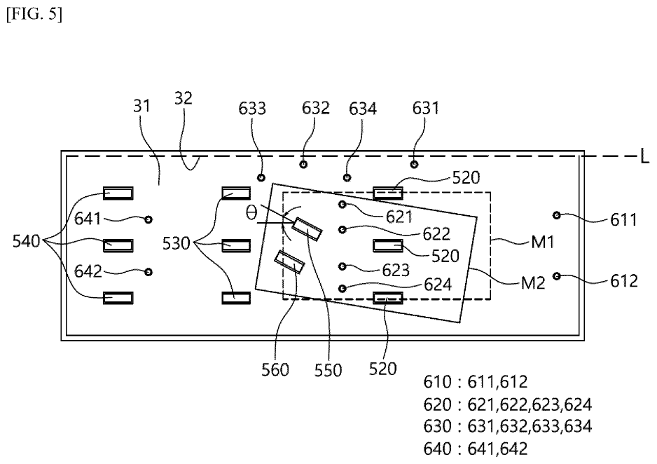

Referring to FIG. 5, the skew correction refers to correcting an inclined angle of a medium M2 that is conveyed in a state that is not parallel to a conveyance direction when a medium M1 is conveyed in a proper position and is inclined to one side, so that the direction is parallel to the conveyance direction of the medium.

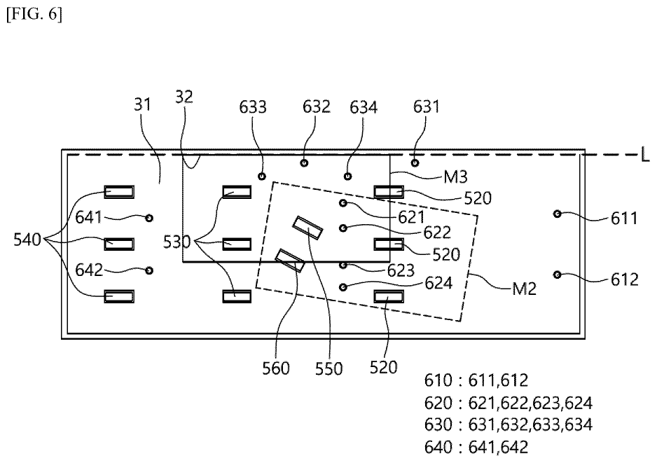

Referring to FIG. 6, the shift correction refers to correcting a medium by moving the medium in a direction that is orthogonal to the conveyance direction when the medium is conveyed in the proper position so that one end of a medium M3 is aligned with a reference surface L formed by an alignment sidewall 32 provided on one side of the medium conveyance surface 31.

The alignment unit 30a includes a main conveyance drive system 100 that provides a driving force for conveying a medium separated into individual sheets, a correction conveyance drive system 200 that provides a driving force for performing alignment correction of the medium, a conveyance solenoid 300 that provides a driving force for controlling the transmission of a driving force for conveying the medium, and a correction solenoid 400 that controls the transmission of a driving force for alignment correction of the medium.

An inlet roller 510 is provided in front of a conveyance path through which the medium of the alignment unit 30a is conveyed, and a plurality of conveyance rollers 520, 520a, 530, 530a, 540, and 540a for conveying the medium are provided behind the inlet roller 510 at a predetermined interval, and a pair of first correction rollers 550 and 550a and a pair of second correction rollers 560 and 560a for alignment correction of the medium are provided.

The plurality of conveyance rollers 520, 520a, 530, 530a, 540, and 540a are composed of pairs of driving conveyance rollers 520, 530, and 540 and idle conveyance rollers 520a, 530a, and 540a that are arranged to be in contact with each other vertically and are rotatably driven to convey the medium.

The first correction rollers 550 and 550a and the second correction rollers 560 and 550a are configured as pairs of driving correction rollers 550 and 560 and idle correction rollers 550a and 560a that are arranged to be in contact with each other vertically and are rotatably driven to perform alignment correction of the medium.

The first correction rollers 550 and 550a and the second correction rollers 560 and 550a are arranged to be inclined at a predetermined angle θ to one side with respect to a normal conveyance direction of the medium.

Conveyance solenoids 300 (300-1 and 300-2) cause the pairs of driving conveyance rollers 520, 530, and 540 and idle conveyance rollers 520a, 530a, and 540a to be in contact with each other during the conveyance of the medium to support and convey the medium, and cause the pairs of driving conveyance rollers 520, 530, and 540 and idle conveyance rollers 520a, 530a, and 540a to be separated from each other during the alignment correction of the medium so that the conveyance of the medium by the pairs of driving conveyance rollers 520, 530, and 540 and idle conveyance rollers 520a, 530a, and 540a is stopped.

The correction solenoid 400 prevents the alignment correction of the medium from being performed by causing the pairs of driving correction rollers 550 and 560 and idle correction rollers 550a and 560a to be spaced apart from each other during the conveyance of the medium, and causes the pairs of driving correction rollers 550 and 560 and idle correction rollers 550a and 560a to be in contact with each other during the alignment correction of the medium so that the alignment correction of the medium is performed.

The main conveyance drive system 100 provides a driving force for driving all of the plurality of conveyance rollers 520, 520a, 530, 530a, 540, and 540a, and the first correction roller 550 is connected the main conveyance drive system 100 and is rotatably driven.

The second correction roller 560 is rotatably driven by the correction conveyance drive system 200 provided separately from the main conveyance drive system 100.

The alignment unit 30a is provided with alignment inlet sensors 610 (611 and 612) for detecting a rear end of the medium entering the alignment unit 30a, a plurality of skew sensors 620 (621, 622, 623, and 624) for detecting whether the medium being conveyed is skewed, a plurality of shift sensors 630 (631, 632, 633, and 634) for detecting whether the medium being conveyed is shifted, and discrimination inlet sensors 640 (641 and 642) for detecting a front end of the medium being conveyed through the alignment unit 30a toward the discrimination unit 30a.

The alignment inlet sensors 610 (611 and 612) may be provided as a pair of alignment inlet sensors 610 at positions spaced apart from each other in a direction orthogonal to the conveyance direction of the medium on an inlet side of the alignment unit 30a.

The plurality of skew sensors 620 (621, 622, 623, and 624) may include first to fourth skew sensors 621, 622, 623, and 624 at positions spaced apart from each other in the direction orthogonal to the conveyance direction of the medium on a front side of the correction rollers 550, 550a, 560, and 560a.

The plurality of shift sensors 630 (631, 632, 633, and 634) may include a first shift sensor 631 and a second shift sensor 632 that are provided at positions close to the reference surface L and spaced apart from each other in the conveyance direction of the medium, and a third shift sensor 633 and a fourth shift sensor 634 that are provided at positions to be spaced in the conveyance direction of the medium at a position further than the distance at which the first shift sensor 631 and the second shift sensor 632 are spaced apart from the reference surface L.

The discrimination inlet sensors 640 (641 and 642) may be provided as a pair of discrimination inlet sensors 640 at positions spaced apart from each other in the direction orthogonal to the conveyance direction of the medium on an outlet side of the alignment unit 30a.

The discrimination unit 30b includes at least one sensor among an image sensor 810 for acquiring an image of the medium and discriminating the type of the medium, a magnetic sensor 820 for detecting a magnetic component within the medium and discriminating the authenticity of the medium, and an ultraviolet sensor 830 for detecting an ultraviolet substance within the medium and discriminating the authenticity of the medium.

Further, the discrimination unit 30b includes an encoder sensor 650 that measures a conveyance speed of the medium by driving the main conveyance drive system 100 and also measures an image scan cycle of the discrimination unit 30b. In this way, by using an encoder sensor for measuring a conveyance path speed and an encoder sensor for measuring an image scan cycle commonly as a single encoder sensor 650, the functions of each encoder sensor may be integrated to simplify the structure thereof.

By using an encoder sensor for measuring a conveyance path speed and an encoder sensor for measuring an image scan cycle to be shared as a single encoder sensor, the functions of the respective encoder sensors may be integrated and the structures of the encoder sensors may be simplified.

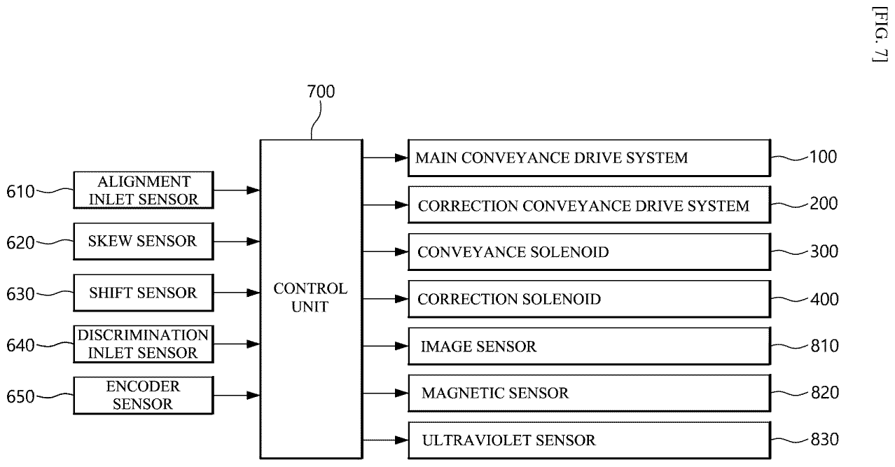

Referring to FIG. 7, signals measured from the alignment inlet sensor 610, the skew sensor 620, the shift sensor 630, the discrimination inlet sensor 640, and the encoder sensor 650 are transmitted to a control unit 700, and the control unit 700 controls the operation of the main conveyance drive system 100, the correction conveyance drive system 200, the conveyance solenoid 300, the correction solenoid 400, the image sensor 810, the magnetic sensor 820, and the ultraviolet sensor 830 on the basis of the received signals.

A start time and an end time at which alignment correction is performed may be set based on the signal detected by the alignment inlet sensor 610.

Based on the signals detected by the skew sensor 620 and the shift sensor 630, a required skew correction angle and shift correction movement amount of the medium being conveyed may be calculated, and accordingly, the driving of the main conveyance drive system 100, the correction conveyance drive system 200, the conveyance solenoid 300, and the correction solenoid 400 may be controlled.

In one embodiment, when skew correction and shift correction of the medium are required, the control unit 700 may control a driving speed of the correction conveyance drive system 200 while stopping the driving of the main conveyance drive system 100 so that the medium being conveyed is aligned.

In another embodiment, when skew correction and shift correction of the medium are required, the control unit 700 may individually control a driving speed of the main conveyance drive system 100 and a driving speed of the correction conveyance drive system 200 so that the medium being conveyed is aligned.

Measurement times and cycles of the image sensor 810, the magnetic sensor 820, and the ultraviolet sensor 830 in the discrimination unit 30b may be set based on the signal passing through the front end of the medium detected by the discrimination inlet sensor 640.

Based on the signal detected by the encoder sensor 650, a conveyance speed of a medium conveyance path and an image scan cycle of the discrimination unit 30b may be checked and controlled to match a set speed and cycle.

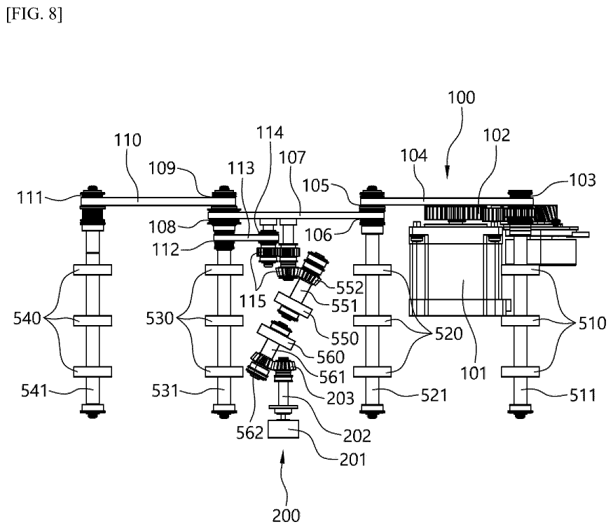

Configurations of the main conveyance drive system 100 and the correction conveyance drive system 200 will be described with reference to FIG. 8.

An inlet roller shaft 511 to which a plurality of inlet rollers 510 are coupled, a first conveyance roller shaft 521 to which a plurality of first conveyance rollers 520 are coupled, a second conveyance roller shaft 531 to which a plurality of second conveyance rollers 530 are coupled, and a third conveyance roller shaft 541 to which a plurality of third conveyance rollers 540 are coupled are provided with at positions spaced a predetermined interval from the front to the rear of the alignment unit 30a.

A first pulley 103 is coupled to one end of the inlet roller shaft 511, a second pulley 105 and a third pulley 106 are coupled to one end of the first conveyance roller shaft 521, a fourth pulley 108 and a fifth pulley 109 are coupled to one end of the second conveyance roller shaft 531, and a sixth pulley 111 is coupled to one end of the third conveyance roller shaft 541.

A rotational driving force of the main conveyance motor 101 is transmitted to the inlet roller shaft 511 through a connection gear 102, is transmitted to the first conveyance roller shaft 521 by a first belt 104 driving the first pulley 103 and the second pulley 105, is transmitted to the second conveyance roller shaft 531 by a second belt 107 driving the third pulley 106 and the fourth pulley 107, and is transmitted to the third conveyance roller shaft 541 by a third belt 110 driving the fifth pulley 109 and the sixth pulley 111.

Meanwhile, a seventh pulley 112 is coupled to the one end of the second conveyance roller shaft 531, an eighth pulley 114 is provided on one side of the second conveyance roller shaft 531 and to which power is transmitted by a fourth belt 113, a connection gear 115 coupled to the same shaft as the eighth pulley 114 is connected to a connection gear 552 coupled to one end of the first correction roller shaft 551 to which the first correction roller 550 is coupled, and thus power is transmitted to the first correction roller 550.

In this way, the main conveyance drive system 100 drives the inlet roller 510, the plurality of first to third conveyance rollers 520, 530, and 540, and the first correction roller 550 in conjunction with the driving force of the main conveyance motor 101.

The correction conveyance drive system 200 is configured such that a rotational driving force of a correction conveyance motor 201 is transmitted to a correction conveyance drive shaft 202, and a connection gear 203 coupled to one end of the correction conveyance drive shaft 202 is connected to a connection gear 562 coupled to one end of the second correction roller shaft 561 to which the second correction roller 560 is coupled, and thus the rotational driving force of the correction conveyance motor 201 is transmitted to the second correction roller 560.

In this way, the correction conveyance drive system 200 is provided separately from the main conveyance drive system 100 so that a rotation speed of the second correction roller 560 may be controlled separately from the rotation of the first correction roller 550.

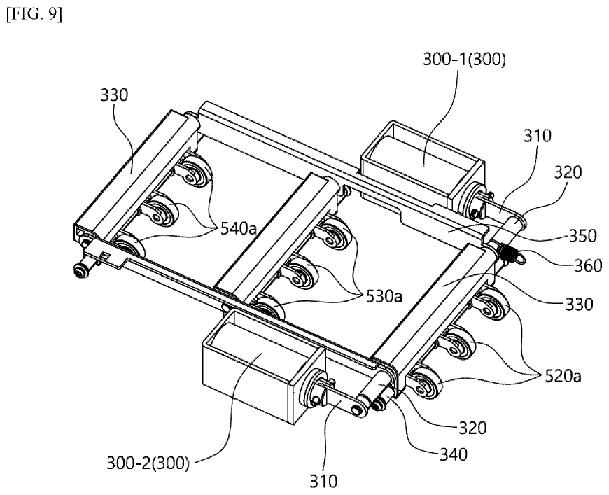

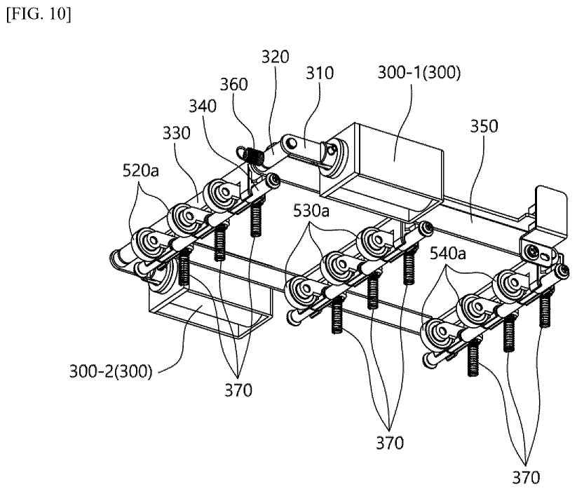

The conveyance solenoids 300 (300-1 and 300-2) and a configuration and operation of a power transmission structure connected thereto will be described with reference to FIGS. 9 to 11.

The conveyance solenoids 300 (300-1 and 300-2) is configured to transmit power to a conveyance solenoid rod 310 that is drawn out or drawn in according to whether power is supplied, a first shaft 320 connected to the conveyance solenoid rod 310, a conveyance link member 330 that has an upper portion through which the first shaft 320 passes and is connected, supports the conveyance roller 520a, and is rotated in conjunction with the movement of the conveyance solenoid rod 310, a second shaft 340 that passes through a lower portion of the conveyance link member 330 and forms the center of rotation of the conveyance link member 330, and a moving member 350 that supports each of the plurality of conveyance rollers 520a, is connected to one side portion of the plurality of conveyance link members 330 arranged to be spaced apart from each other in the conveyance direction of the medium, and is moved forward and rearward to simultaneously rotate the plurality of conveyance link members 330.

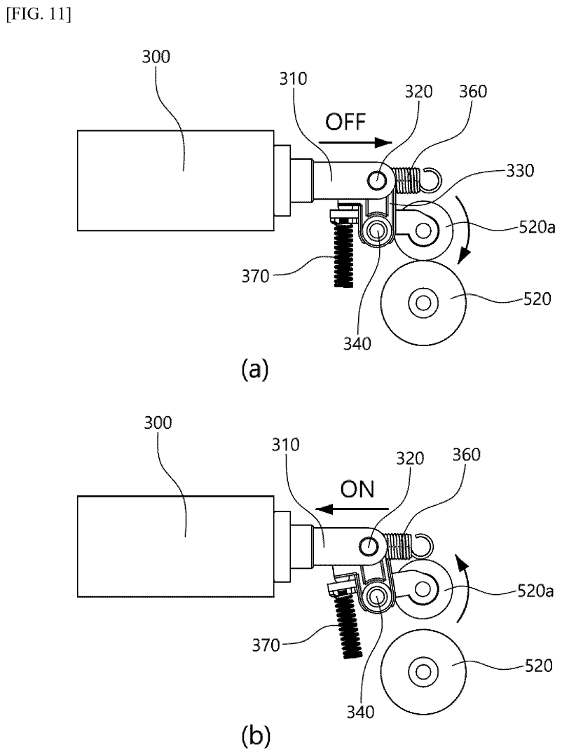

FIG. 11A illustrates that, when the conveyance solenoid 300 is in an OFF state with no power applied, the conveyance solenoid rod 310 is drawn outward from the conveyance solenoid 300, the conveyance link member 330 is rotated clockwise around the second shaft 340 in conjunction with the conveyance solenoid rod 310, and thus the idle conveyance roller 520a supported by the conveyance link member 330 comes into contact with the driven conveyance roller 520, and the medium supported therebetween is conveyed.

FIG. 11B illustrates that when the conveyance solenoid 300 is in an ON state with power applied, the conveyance solenoid rod 310 is drawn into an inside of the conveyance solenoid 300, the conveyance link member 330 is rotated counterclockwise around the second shaft 340 in conjunction with the conveyance solenoid rod 310, the idle conveyance roller 520a supported by the conveyance link member 330 is spaced upward from the driven conveyance roller 520 and thus the conveyance of the medium is stopped even when the medium is positioned therebetween.

Meanwhile, as components for rapidly returning the idle conveyance roller 520a to an initial state in which the idle conveyance roller 520a comes into contact with the driven conveyance roller 520 when the state is changed from a power ON state to a power OFF state, a first elastic member 360 that is connected to the first shaft 320 and exerts an elastic force in a direction in which the driven conveyance rollers 520, 530, and 540 come into contact with the idle conveyance rollers 520a, 530a, and 540a, and a second elastic member 370 that is connected to the conveyance link member 330 and exerts an elastic force in a direction in which the driven conveyance rollers 520, 530, and 540 come into contact with the idle conveyance rollers 520a, 530a, and 540a are provided.

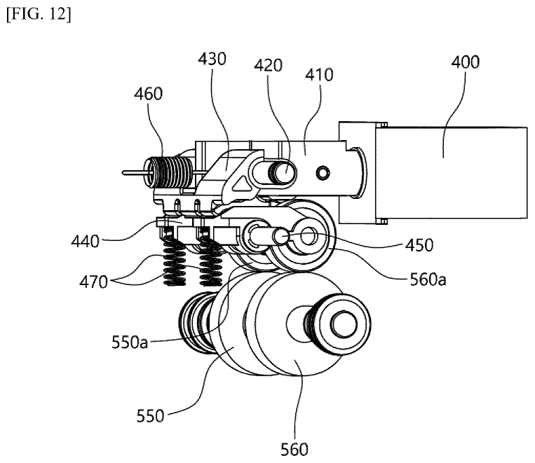

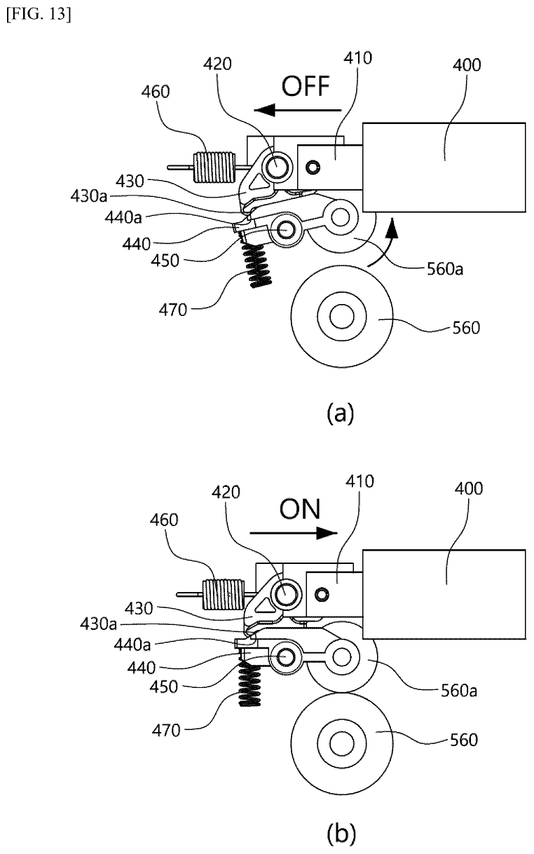

The correction solenoid 400 and a configuration and operation of a power transmission structure connected thereto will be described with reference to FIGS. 12 and 13.

The correction solenoid 400 is configured to transmit power to a correction solenoid rod 410 that is drawn out or drawn in according to whether power is supplied, a third shaft 420 connected to the correction solenoid rod 410, a first correction link member 430 that has an upper portion through which the third shaft 420 passes and is connected, and is moved forward and rearward in conjunction with the movement of the correction solenoid rod 410, a fourth shaft 450 that passes through and is connected to a lower portion of the first correction link member 430, and a second correction link member 440 through which the fourth shaft 450 passes and is connected, and which comes into contact with a lower portion of the first correction link member 410, is rotated around the fourth shaft 450 as the center of rotation in conjunction with the forward and backward movement of the first correction link member 410, and supports the correction rollers 550a and 560a.

A first inclined surface 430a may be formed on a lower surface of the first correction link member 430, a second inclined surface 440a may be formed on an upper surface of the second correction link member 440 to be in contact with the first inclined surface 430a, and the second correction link member 440 may be rotated by a force exerted by the first inclined surface 430a on the second inclined surface 440a in conjunction with the movement of the correction solenoid rod 410.

FIG. 13A illustrates that when the correction solenoid 400 is in an OFF state with no power applied, the correction solenoid rod 410 is drawn outward from the correction solenoid 400, the first correction link member 430 is moved in a direction in which the correction solenoid rod 410 is drawn out in conjunction with the correction solenoid rod 410, and the second correction link member 440 and the idle correction roller 560a supported thereon are subjected to a force in a counterclockwise direction by the first correction link member 430, and are rotated counterclockwise around the fourth shaft 450 as the center of rotation, and are positioned above the driven correction roller 560. Therefore, even when the medium is positioned between the idle correction roller 560a and the driven correction roller 560, the alignment correction is not performed.

FIG. 13B illustrates that when the correction solenoid 400 is in an ON state with power applied, the correction solenoid rod 410 is drawn into an inside of the correction solenoid 400, the first correction link member 430 is moved in a direction in which the correction solenoid rod 410 is drawn in in conjunction with the correction solenoid rod 410, and the second correction link member 440 and the idle correction roller 560a supported thereon are subjected to a force in a clockwise direction by the first correction link member 430, and are rotated in the clockwise direction around the fourth shaft 450 as the center of rotation, and come into contact with the driven correction roller 560. Therefore, alignment correction may be performed by supporting the medium between the idle correction roller 560a and the driven correction roller 560.

Meanwhile, as components for rapidly returning the idle correction roller 560a to an initial state in which the idle correction roller 560a is separated from the driven correction roller 560 when the state is changed from a power ON state to a power OFF state, a third elastic member 460 that is connected to the first correction link member 430 and exerts an elastic force in a direction in which the driven correction rollers 550 and 560 are separated from the idle correction rollers 550a and 560a, and a fourth elastic member 470 that is connected to the second correction link member 440 and exerts an elastic force in a direction in which the driven correction rollers 550 and 560 are separated from the idle correction rollers 550a and 560a are provided.

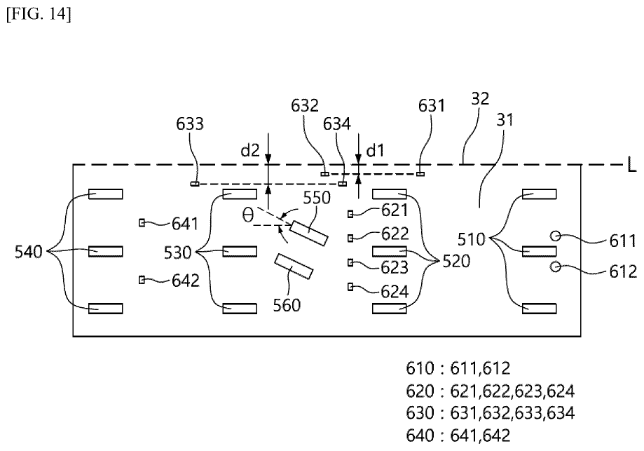

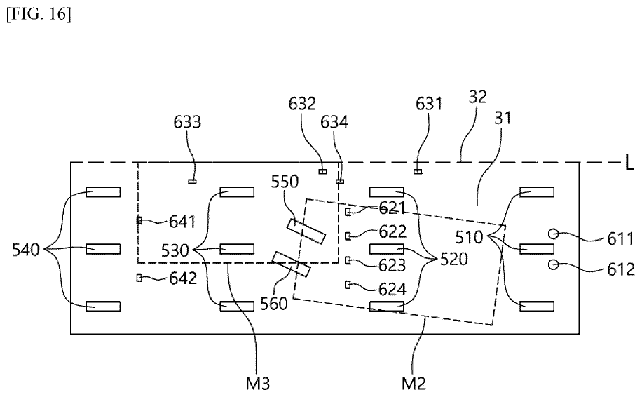

Referring to FIGS. 14 to 16, the skew correction refers to correcting an inclined angle of a medium M2 that is conveyed in a state that is not parallel to a conveyance direction when a medium M1 is conveyed in a proper position and is inclined to one side, so that the direction is parallel to the conveyance direction of the medium. The shift correction refers to correcting a medium by moving the medium in a direction that is orthogonal to the conveyance direction when the medium is conveyed in the proper position so that one end of a medium M3 is aligned with a reference surface L formed by an alignment sidewall 32 provided on one side of the medium conveyance surface 31.

The alignment unit 30a includes a main conveyance drive system 100 that provides a driving force for conveying a medium separated into individual sheets, a correction conveyance drive system 200 that provides a driving force for performing alignment correction of the medium, a conveyance solenoid 300 that provides a driving force for controlling the transmission of a driving force for conveying the medium, and a correction solenoid 400 that controls the transmission of a driving force for alignment correction of the medium.

An inlet roller 510 is provided in front of a conveyance path of the alignment unit 30a through which the medium is conveyed, a plurality of conveyance rollers 520, 520a, 530, 530a, 540, and 540a for conveying the medium are provided behind the inlet roller 510 at a predetermined interval, and a pair of first correction rollers 550 and 550a and a pair of second correction rollers 560 and 560a for alignment correction of the medium are provided.

The plurality of conveyance rollers 520, 520a, 530, 530a, 540, and 540a are composed of pairs of driving conveyance rollers 520, 530, and 540 and idle conveyance rollers 520a, 530a, and 540a that are arranged to be in contact with each other vertically and are rotatably driven to convey the medium.

The first correction rollers 550 and 550a and the second correction rollers 560 and 550a are configured as pairs of driving correction rollers 550 and 560 and idle correction rollers 550a and 560a that are arranged to be in contact with each other vertically and are rotatably driven to perform alignment correction of the medium.

The first correction rollers 550 and 550a and the second correction rollers 560 and 550a are arranged to be inclined at a predetermined angle θ to one side with respect to a normal conveyance direction of the medium.

Conveyance solenoids 300 (300-1 and 300-2) cause the pairs of driving conveyance rollers 520, 530, and 540 and idle conveyance rollers 520a, 530a, and 540a to be in contact with each other during the conveyance of the medium to support and convey the medium, and cause the pairs of driving conveyance rollers 520, 530, and 540 and idle conveyance rollers 520a, 530a, and 540a to be separated from each other during the alignment correction of the medium so that the conveyance of the medium by the pairs of driving conveyance rollers 520, 530, and 540 and idle conveyance rollers 520a, 530a, and 540a is stopped.

The correction solenoid 400 prevents the alignment correction of the medium from being performed by causing the pairs of driving correction rollers 550 and 560 and idle correction rollers 550a and 560a to be spaced apart from each other during the conveyance of the medium, and causes the pairs of driving correction rollers 550 and 560 and idle correction rollers 550a and 560a to be in contact with each other during the alignment correction of the medium so that the alignment correction of the medium is performed.

The main conveyance drive system 100 provides a driving force for driving all of the plurality of conveyance rollers 520, 520a, 530, 530a, 540, and 540a, and the first correction roller 550 is connected the main conveyance drive system 100 and is rotatably driven.

The second correction roller 560 is rotatably driven by the correction conveyance drive system 200 provided separately from the main conveyance drive system 100.

In this way, since the first correction roller 550 and the second correction roller 560 are driven separately by different drive systems, the rotational speed of the first correction roller 550 and the second correction roller 560 may be individually controlled to control the rotational angle of the medium in the direction of the fast rotational speed, thereby accurately controlling the skew correction of the medium.

The alignment unit 30a is provided with alignment inlet sensors 610 (611 and 612) for detecting a rear end of the medium entering the alignment unit 30a, a plurality of skew sensors 620 (621, 622, 623, and 624) for detecting whether the medium being conveyed is skewed, a plurality of shift sensors 630 (631, 632, 633, and 634) for detecting whether the medium being conveyed is shifted, and discrimination inlet sensors 640 (641 and 642) for detecting a front end of the medium being conveyed through the alignment unit 30a toward the discrimination unit 30a.

The alignment inlet sensors 610 (611 and 612) may be provided as a pair of alignment inlet sensors 610 at positions spaced apart from each other in a direction orthogonal to the conveyance direction of the medium on an inlet side of the alignment unit 30a.

The plurality of skew sensors 620 (621, 622, 623, and 624) may include first to fourth skew sensors 621, 622, 623, and 624 at positions spaced apart from each other in the direction orthogonal to the conveyance direction of the medium on a front side of the correction rollers 550, 550a, 560, and 560a.

Referring to FIG. 14, the plurality of shift sensors 630 (631, 632, 633, and 634) may be composed of a first shift sensor 631 and a second shift sensor 632 that are provided at positions close to the reference surface L and spaced a distance d1 from each other in the conveyance direction of the medium, and a third shift sensor 633 and a fourth shift sensor 634 that are provided at positions to be spaced apart a distance d2 in the conveyance direction of the medium at a position further than the distance d1 at which the first shift sensor 631 and the second shift sensor 632 are spaced apart from the reference surface L.

The discrimination inlet sensors 640 (641 and 642) may be provided as a pair of discrimination inlet sensors 640 at positions spaced apart from each other in the direction orthogonal to the conveyance direction of the medium on an outlet side of the alignment unit 30a.

The discrimination unit 30b includes at least one sensor among an image sensor 810 for acquiring an image of the medium and discriminating the type of the medium, a magnetic sensor 820 for detecting a magnetic component within the medium and discriminating the authenticity of the medium, and an ultraviolet sensor 830 for detecting an ultraviolet substance within the medium and discriminating the authenticity of the medium.

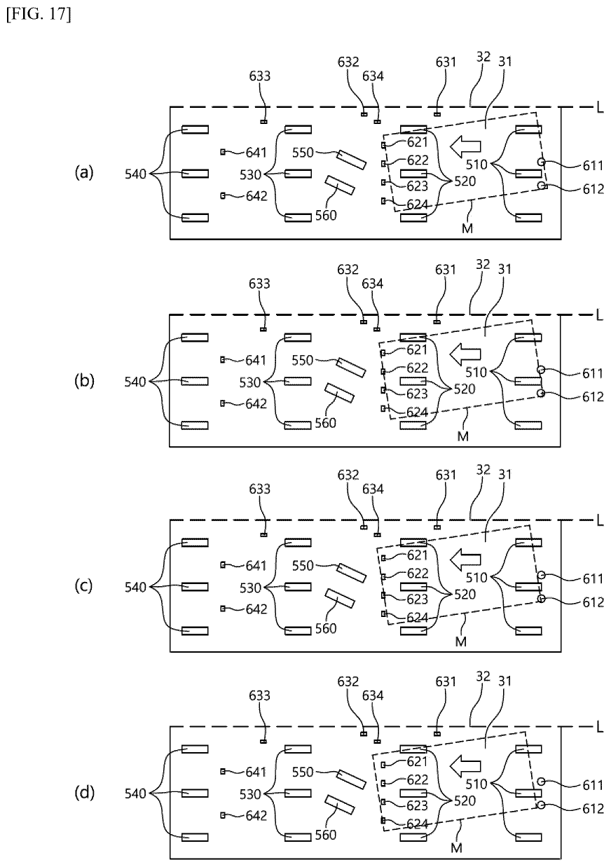

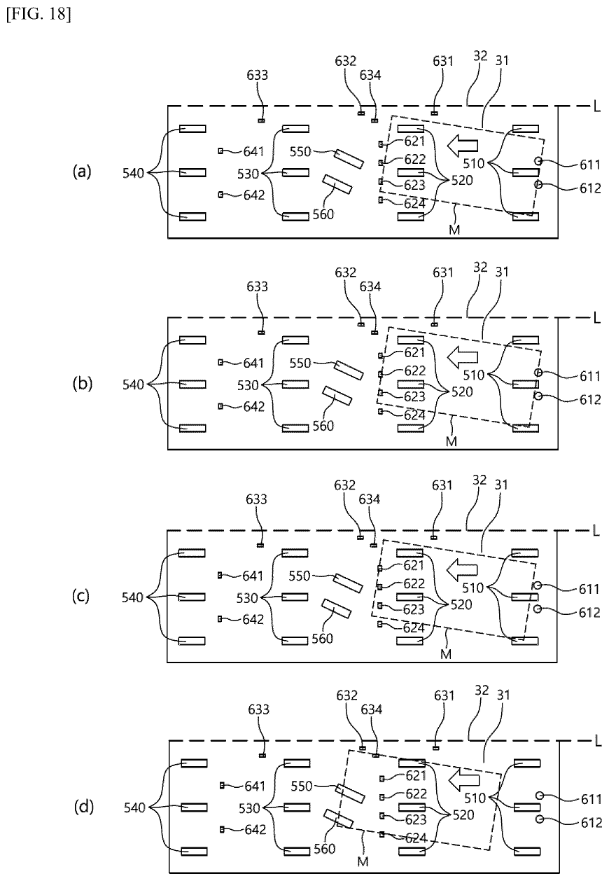

Hereinafter, embodiments of determining the degree of skew of a medium and performing skew correction in the medium alignment device of the present invention will be described with reference to FIGS. 17 and 18.

In the medium alignment device, a plurality of skew sensors 620 for determining the degree of skew of a medium may be provided as at least three skew sensors 620 at positions spaced apart from each other in a direction orthogonal to the conveyance direction of the medium on a front side of the correction rollers 550 and 560.

In the present embodiment, the skew sensors 620 are composed of first to fourth skew sensors 621, 622, 623, and 624.

Data detected by the plurality of skew sensors 620 (621, 622, 623, and 624) is transmitted to the control unit 700, and the control unit 700 calculates the degree of skew of the medium on the basis of only pieces of data having an arithmetic sequence relationship among the data detected by the plurality of skew sensors 620 (621, 622, 623, and 624).

As illustrated in FIGS. 17A, 17B, 17C, and 17D, when the medium M is conveyed while being skewed and a front end portion thereof sequentially passes through a first skew sensor 621, a second skew sensor 622, a third skew sensor 623, and a fourth skew sensor 624 and is detected, time data detected by the four skew sensors 621, 622, 623, and 624 are in an arithmetic sequence relationship with a constant time interval.

As illustrated in FIGS. 18A, 18B, 18C, and 18D, when the medium M is conveyed while being skewed and an edge portion of the front end thereof enters between the third skew sensor 623 and the fourth skew sensor 624, the medium is detected in the order of the third skew sensor 623, the second skew sensor 622, the first skew sensor 621, and the fourth skew sensor 624. In this case, the third skew sensor 623, the second skew sensor 622, and the first skew sensor 621 are in an arithmetic sequence relationship, but the first skew sensor 621 is not in an arithmetic sequence relationship, and thus data detected by the first skew sensor 621 is excluded from the data for determining whether the medium is skewed.

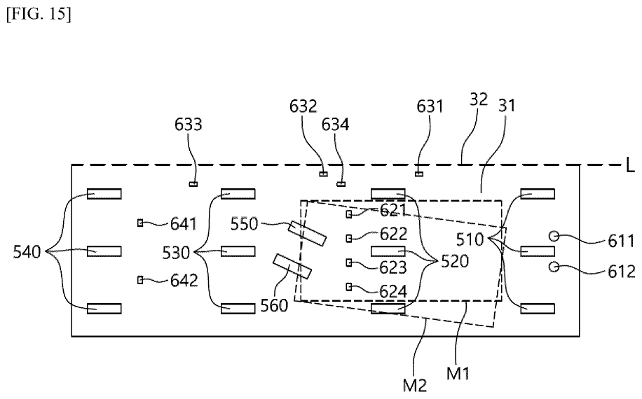

The control unit 700 calculates the degree of skew of the medium on the basis of two pieces of data having the largest detection time difference among the data having an arithmetic sequence relationship detected by the plurality of skew sensors 620 (621, 622, 623, and 624). In the case of FIG. 15, whether the medium is skewed is determined using the data detected by the third skew sensor 623 and the first skew sensor 621.

The degree of skew of the medium may be determined by applying a trigonometric formula on the basis of a distance between the skew sensors that have detected the two pieces of data, a difference between times at which the skew sensors that have detected the two pieces of data each detected the medium, and a conveyance speed of the medium.

In this way, by determining the degree of skew of the medium on the basis of the pieces of data in an arithmetic sequence relationship among the pieces of data detected by the plurality of skew sensors 620 (621, 622, 623, and 624), the direction and angle of skew of the medium may be accurately calculated to determine the degree of skew.

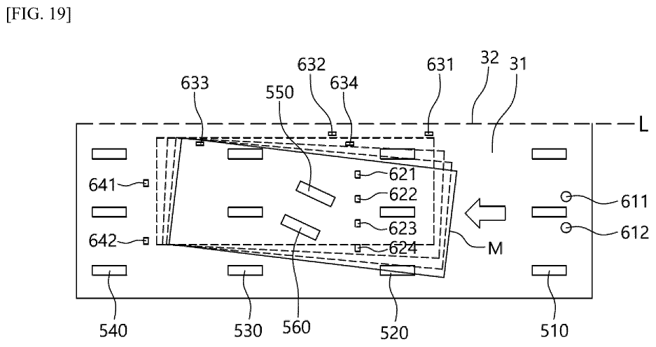

Hereinafter, embodiments of determining the degree of shift of the medium and performing shift correction in the medium alignment device of the present invention will be described with reference to FIGS. 19 to 24.

The plurality of shift sensors 630 (631, 632, 633, and 634) may be composed of a first shift sensor 631 and a second shift sensor 632 that are provided at positions close to the reference surface L and spaced a distance d1 from each other in the conveyance direction of the medium, and a third shift sensor 633 and a fourth shift sensor 634 that are provided at positions to be spaced apart a distance d2 in the conveyance direction of the medium at a position further than the distance d1 at which the first shift sensor 631 and the second shift sensor 632 are spaced apart from the reference surface L.

When determining whether the medium is shifted, data detected by the plurality of shift sensors 630 (631, 632, 633, and 634) is transmitted to the control unit 700, and the control unit 700 controls shift correction to be performed by determining the degree of shift of the medium being conveyed on the basis of signals detected by the plurality of shift sensors 630 (631, 632, 633, and 634) and differentially setting a time at which the shift correction is performed according to the degree of shift.

FIGS. 19 to 24 illustrate cases in which the medium is conveyed at various positions, and a solid line for the medium M indicates a position at which the medium entered before skew correction, and a dotted line for the medium M indicates a process of performing skew correction and shift correction of the medium.

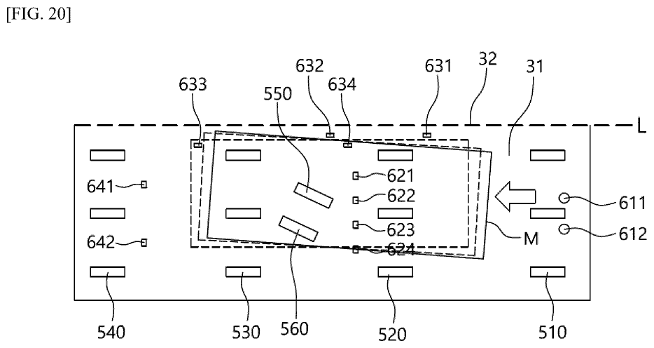

In one embodiment, as illustrated in FIGS. 19 and 20, when the medium is detected by only any one of the third shift sensor 633 and the fourth shift sensor 634, the control unit 700 may control skew correction to be performed until the medium is detected by the remaining one of the third shift sensor 633 and the fourth shift sensor 634 and then shift correction to be performed for a first set period of time. The first set period of time may be set in additional consideration of a movement time corresponding to a distance from the third shift sensor 633 and the fourth shift sensor 634 to the reference surface L or a delay time between a time when a control signal is applied and a time when the correction rollers 550 and 560 are actually driven to support the medium.

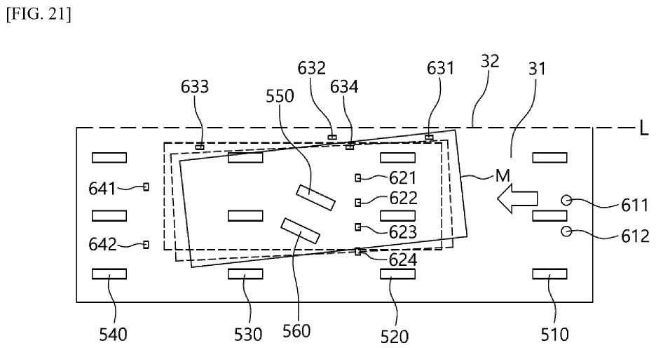

In another embodiment, as illustrated in FIG. 21, when the medium is detected by the first shift sensor 631 and the fourth shift sensor 634 among the plurality of shift sensors 630 (631, 632, 633, and 634), the control unit 700 may control skew correction to be performed until the medium is detected by the third shift sensor 633 and then shift correction to be performed for the first set period of time.

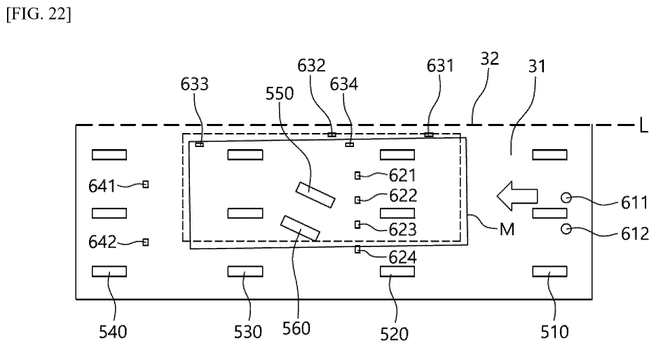

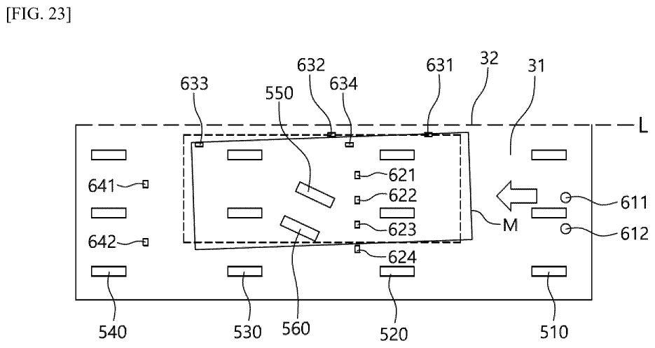

In still another embodiment, when the medium is detected by the third shift sensor 633 and the fourth shift sensor 634 among the plurality of shift sensors 630 (631, 632, 633, and 634) as illustrated in FIG. 22, or when the medium is detected by the first shift sensor 633, the third shift sensor 633, and the fourth shift sensor 634 as illustrated in FIG. 23, the control unit 700 may control skew correction to be performed for a second set period of time and then shift correction to be performed for a third set period of time. The second set period of time and the third set period of time may be set to the shortest on-off time possible for the correction solenoid 400 to operate during skew correction and shift correction.

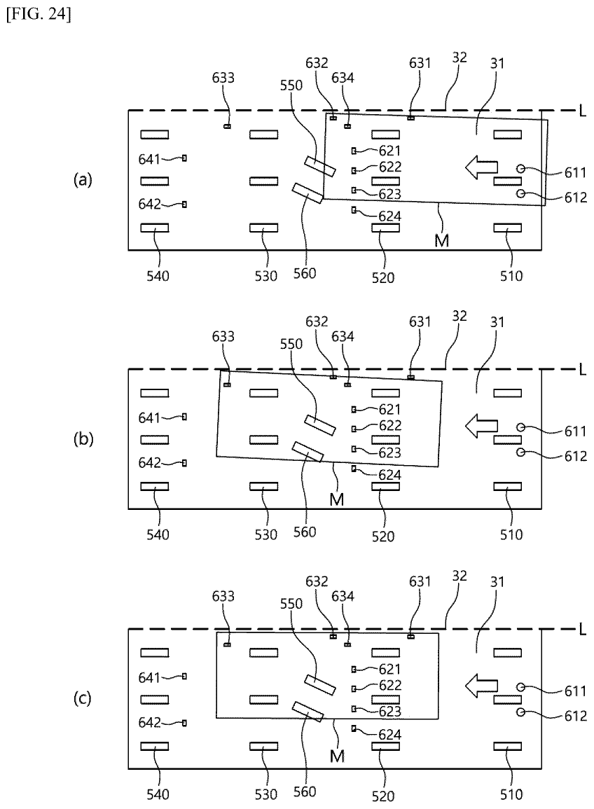

Meanwhile, as illustrated in FIGS. 24A, 24B, and 24C, when the medium is detected by the first shift sensor 631, the second shift sensor 632, and the fourth shift sensor 634 among the plurality of shift sensors 630 (631, 632, 633, and 634), when the medium is detected by the second shift sensor 632, the third shift sensor 633, and the fourth shift sensor 634, or when the medium is detected by all of the plurality of shift sensors 630 (631, 632, 633, and 634), the control unit 700 may control the medium to be conveyed without skew correction and shift correction.

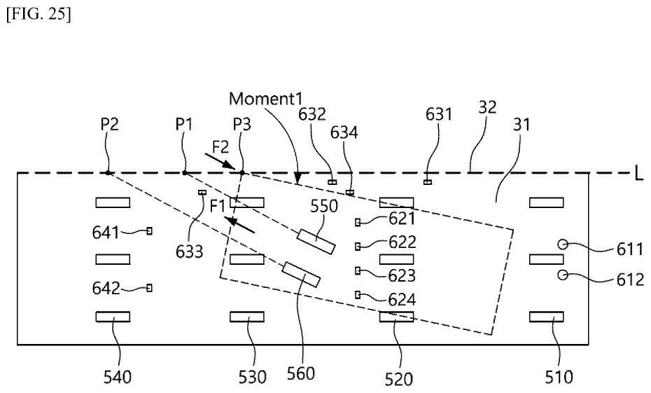

Hereinafter, problems in skew correction and shift correction of a medium and a configuration and operation of the present invention for solving the problems will be described with reference to FIGS. 25 to 27.

In the process of the medium being moved while being skew-corrected and shift-corrected, an alignment state of the medium may be maintained or misaligned according to a position at which a front end of the medium M comes into contact with one sidewall 32 of the medium conveyance surface 31.

An area between two points P1 and P3 where an imaginary extension line extending from a pair of correction rollers 550 and 560 toward the one sidewall 32 of the medium conveyance surface 31 meet the one sidewall 32 of the medium conveyance surface 31 is defined as the reference point.

As illustrated in FIG. 25, when a position P3 at which the front end of the medium M comes into contact with the one sidewall 32 of the medium conveyance surface 31 is positioned in front of the medium (right side in the drawing) relative to the reference point, a clockwise moment (Moment 1) is applied to the medium M on the basis of the contact point P3 due to a direction of a force F1 applied to the medium M by the pair of correction rollers 550 and 560 and a direction of a force F2 applied to the medium M by the one sidewall 32 of the medium conveyance surface 31 due to the reaction, and thus one end of the medium M is rotated in a clockwise direction from the reference surface L and the alignment state becomes misaligned.

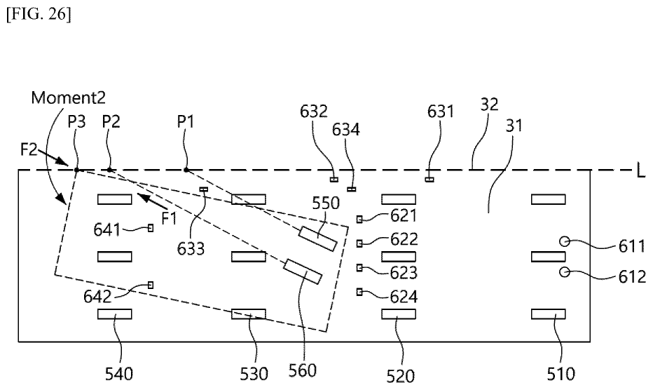

As illustrated in FIG. 26, when the position P3 where the front end of the medium M comes into contact with the one sidewall 32 of the medium conveyance surface 31 is positioned to the right of the medium (left side in the drawing) relative to the reference point, a counterclockwise moment (Moment 2) is applied to the medium M on the basis of the contact point P3 due to the direction of the force F1 applied to the medium M by the pair of correction rollers 550 and 560 and the direction of the force F2 applied to the medium M by the one sidewall 32 of the medium conveyance surface 31 due to the reaction, and thus the one end of the medium M is rotated in a counterclockwise direction to be in close contact with the reference surface L and maintains the aligned state.

In one embodiment of the present invention, when performing skew correction and shift correction of the medium, the control unit 700 is configured to control a rotation timing of the correction rollers 550 and 560 so that the edge portion of the front end of the medium M comes into contact with the one sidewall 32 of the medium conveyance surface 31 at a rear position of the reference point, on the basis of the reference point (point between P1 and P2) where the direction of the force F1 applied to the medium M1 by the correction rollers 550 and 560 and the direction of the force F2 applied to the medium M from the one sidewall 32 of the medium conveyance surface 31 that comes into contact with the front end of the medium M are identical.

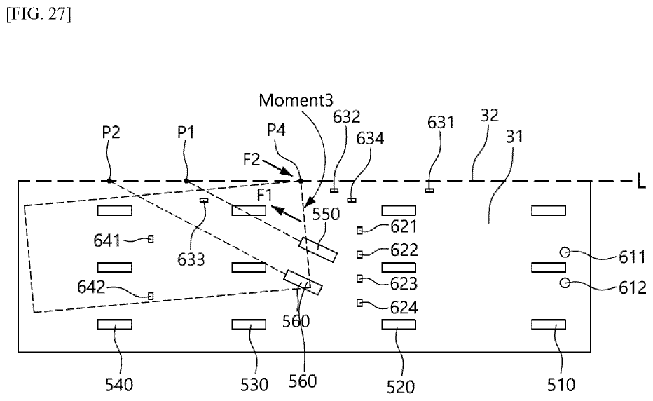

In another embodiment, as illustrated in FIG. 27, when performing skew correction and shift correction of the medium, the control unit 700 is configured to control a rotation timing of the correction rollers 550 and 560 so that an edge portion of the rear end of the medium M comes into contact with the one sidewall 32 of the medium conveyance surface 31 before the edge portion of the front end of the medium M or the one end of the medium M.

For example, when the skew correction is performed in a state in which an edge portion of one side of the front end of the medium M is skewed closer to the reference surface L than an edge portion of one side of the rear end of the medium M, the control unit 700 may control the rotational drive of the correction rollers 550 and 560 so that the edge portion of the rear end of the medium M first comes into contact with the one sidewall 32 of the medium conveyance surface 31 by overcorrection more than the skew correction amount that makes the one end of the medium be parallel to the reference surface L.

In this way, when the skew correction amount is overcorrected so that the edge portion of the rear end of the medium M comes into contact with the one sidewall 32 of the medium conveyance surface 31, a clockwise moment (Moment 3) is applied to the medium after the edge portion of the rear end of the medium M first comes into contact with the one sidewall 32 of the medium conveyance surface 31, and thus the one end of the medium may be naturally aligned parallel to the reference surface L while moving the medium in the conveyance direction.

As described above, the present invention is not limited to the above-described embodiments, and obvious modifications can be made by those skilled in the art to which the present invention pertains without departing from the technical spirit of the present invention claimed in the claims, and such modifications fall within the scope of the present invention.

1. An alignment and discrimination module of a medium deposit device, comprising an alignment unit configured to perform alignment correction so that a medium being conveyed is aligned,
wherein the alignment unit includes a pair of a first correction roller and a second correction roller that are inclined toward one side with respect to a conveyance direction of the medium so as to face a reference surface on one side of a medium conveyance surface in order to perform skew correction so that the medium being conveyed is parallel to the conveyance direction, and at the same time, perform shift correction so that one end of the medium is aligned with the reference surface.

2. The alignment and discrimination module of claim 1, wherein the first correction roller is connected to a main conveyance drive system that drives all of a plurality of conveyance rollers arranged at a predetermined interval in the conveyance direction of the medium for conveyance of the medium and is rotatably driven, and the second correction roller is rotatably driven by a correction conveyance drive system.

3. The alignment and discrimination module of claim 1, further comprising:
a plurality of skew sensors configured to detect whether the medium being conveyed is skewed;
a plurality of shift sensors configured to detect whether the medium being conveyed is shifted; and
a control unit configured to control skew correction and shift correction of the medium to be performed by determining a degree of skew of the medium on the basis of data detected by the plurality of skew sensors and determining a degree of shift of the medium on the basis of data detected by the plurality of shift sensors.

4. The alignment and discrimination module of claim 2, wherein the control unit controls a driving speed of the correction conveyance drive system in a state in which the driving of the main conveyance drive system is stopped so that the medium being conveyed is in an aligned state when skew correction and shift correction of the medium are required.

5. The alignment and discrimination module of claim 2, wherein the control unit individually controls a driving speed of the main conveyance drive system and a driving speed of the correction conveyance drive system so that the medium being conveyed is in an aligned state when skew correction and shift correction of the medium are required.

6. The alignment and discrimination module of claim 4, wherein each of the plurality of conveyance rollers is composed of a pair of a driving conveyance roller and an idle conveyance roller that are arranged to be in contact with each other up and down and are rotatably driven to convey the medium,
each of the first correction roller and the second correction roller is composed of a pair of a driving correction roller and an idle correction roller that are arranged to be in contact with each other up and down and are rotatably driven to align and correct the medium, and
the alignment and discrimination module includes:
a conveyance solenoid that causes the pair of the driving conveyance roller and the idle conveyance roller to be in contact with each other during the conveyance of the medium to support and convey the medium, and cause the pair of the driving conveyance roller and the idle conveyance roller to be separated from each other during the alignment correction of the medium so that the conveyance of the medium by the pair of the driving conveyance roller and the idle conveyance roller is stopped; and
a correction solenoid that causes the alignment correction of the medium not to be performed from being performed by causing the pair of the driving correction roller and the idle correction roller to be separated from each other during the conveyance of the medium, and causes the pair of the driving correction roller and the idle correction roller to be in contact with each other during the alignment correction of the medium so that the alignment correction of the medium is performed.

7. The alignment and discrimination module of claim 6, wherein the conveyance solenoid is configured to transmit power to a conveyance solenoid rod that is drawn out or drawn in according to whether power is supplied, a first shaft connected to the conveyance solenoid rod, a conveyance link member that has an upper portion through which the first shaft passes and is connected, supports the conveyance roller, and is rotated in conjunction with the movement of the conveyance solenoid rod, a second shaft that passes through a lower portion of the conveyance link member and forms a center of rotation of the conveyance link member, and a moving member that supports each of the plurality of conveyance rollers, is connected to one side portion of the plurality of conveyance link members arranged to be spaced apart from each other in the conveyance direction of the medium, and is moved forward and rearward to simultaneously rotate the plurality of conveyance link members.

8. The alignment and discrimination module of claim 6, wherein the correction solenoid is configured to transmit power to a correction solenoid rod that is drawn out or drawn in according to whether power is supplied, a third shaft connected to the correction solenoid rod, a first correction link member that has an upper portion through which the third shaft passes and is connected, and is moved forward and rearward in conjunction with the movement of the correction solenoid rod, a fourth shaft that passes through and is connected to a lower portion of the first correction link member, and a second correction link member through which the fourth shaft passes and is connected, and which comes into contact with a lower portion of the first correction link member, is rotated around the fourth shaft as the center of rotation in conjunction with the forward and backward movement of the first correction link member, and supports the first correction roller and the second correction roller.

9. The alignment and discrimination module of claim 8, wherein a first inclined surface is formed on a lower surface of the first correction link member,
a second inclined surface is formed on an upper surface of the second correction link member to be in contact with the first inclined surface, and
the second correction link member is rotated by a force exerted by the first inclined surface on the second inclined surface in conjunction with the movement of the correction solenoid rod.

10. The alignment and discrimination module of claim 1, further comprising a discrimination unit configured to discriminate a type and authenticity of the medium,
wherein the alignment unit and the discrimination unit are formed as an integrated structure.

11. The alignment and discrimination module of claim 10, wherein the discrimination unit includes at least one sensor among an image sensor for acquiring an image of the medium and discriminating the type of the medium, a magnetic sensor for detecting a magnetic component within the medium and discriminating the authenticity of the medium, and an ultraviolet sensor for detecting an ultraviolet substance within the medium and discriminating the authenticity of the medium.

12. The alignment and discrimination module of claim 2, further comprising a discrimination unit configured to discriminate a type and authenticity of the medium; and
an encoder sensor configured to measure a conveyance speed of the medium by driving the main conveyance drive system and also measures an image scan cycle of the discrimination unit.

13. The alignment and discrimination module of claim 3, wherein the plurality of skew sensors are provided as at least three skew sensors at positions spaced apart from each other in a direction orthogonal to the conveyance direction of the medium on a front side of the first correction roller and the second correction roller.

14. The alignment and discrimination module of claim 13, wherein, when determining whether the medium is skewed, data detected by the plurality of skew sensors is transmitted to the control unit, and
the control unit calculates the degree of skew of the medium on the basis of only pieces of data having an arithmetic sequence relationship among the data detected by the plurality of skew sensors.

15. The alignment and discrimination module of claim 14, wherein the plurality of skew sensors are provided as four or more skew sensors,
wherein the control unit calculates the degree of skew of the medium on the basis of two pieces of data having a largest detection time difference among the data having an arithmetic sequence relationship detected by the plurality of skew sensors.

16. The alignment and discrimination module of claim 13, wherein the control unit determines the degree of skew of the medium on the basis of a distance between the skew sensors that have detected the two pieces of data, a difference between times at which the skew sensors that have detected the two pieces of data each detected the medium, and a conveyance speed of the medium.

17. The alignment and discrimination module of claim 3, wherein the plurality of shift sensors include a first shift sensor and a second shift sensor which are provided at positions close to the reference surface and spaced apart from each other in the conveyance direction of the medium, and a third shift sensor and a fourth shift sensor which are provided at positions to be spaced in the conveyance direction of the medium at a position further than the distance at which the first shift sensor and the second shift sensor are spaced apart from the reference surface.

18. The alignment and discrimination module of claim 17, wherein, when determining whether the medium is shifted, data detected by the plurality of shift sensors is transmitted to the control unit, and
the control unit controls shift correction to be performed by determining the degree of shift of the medium being conveyed on the basis of signals detected by the plurality of shift sensors and differentially setting a time at which the shift correction is performed according to the degree of shift.

19. The alignment and discrimination module of claim 18, wherein, when the medium is detected by only any one of the third shift sensor and the fourth shift, the control unit controls skew correction to be performed until the medium is detected by the remaining one of the third shift sensor and the fourth shift sensor and then shift correction to be performed for a first set period of time.

20. The alignment and discrimination module of claim 18, wherein, when the medium is detected by the first shift sensor and the fourth shift sensor among the plurality of shift sensors, the control unit controls skew correction to be performed until the medium is detected by the third shift sensor and then shift correction to be performed for a first set period of time.

21. The alignment and discrimination module of claim 18, wherein, when the medium is detected by the third shift sensor and the fourth shift sensor among the plurality of shift sensors or when the medium is detected by the first shift sensor, the third shift sensor, and the fourth shift sensor, the control unit controls skew correction to be performed for a second set period of time and then shift correction to be performed for a third set period of time.

22. The alignment and discrimination module of claim 18, wherein, when the medium is detected by the first shift sensor, the second shift sensor, and the fourth shift sensor among the plurality of shift sensors, when the medium is detected by the second shift sensor, the third shift sensor, and the fourth shift sensor, or when the medium is detected by all of the plurality of shift sensors, the control unit controls the medium to be conveyed without skew correction and shift correction.

23. The alignment and discrimination module of claim 1, further comprising a control unit configured to control a rotation timing of the pair of the first correction roller and the second correction roller so that an edge portion of a front end of the medium comes into contact with one sidewall of the medium conveyance surface at a rear position of a reference point, on the basis of the reference point where a direction of a force applied to the medium by the pair of the first correction roller and the second correction roller and a direction of a force applied to the medium from the one sidewall of the medium conveyance surface that comes into contact with the front end of the medium are identical when performing skew correction and shift correction of the medium.

24. The alignment and discrimination module of claim 23, wherein an area between two points and where an imaginary extension line extending from the pair of the first correction roller and the second correction roller toward the one sidewall of the medium conveyance surface meet the one sidewall of the medium conveyance surface is set as the reference point.

25. The alignment and discrimination module of claim 24, wherein, when the skew correction is performed in a state in which an edge portion of one side of the front end of the medium is skewed closer to the reference surface than an edge portion of one side of a rear end of the medium is, the control unit controls the rotational drive of the pair of the first correction roller and the second correction roller so that the edge portion of the rear end of the medium first comes into contact with the one sidewall of the medium conveyance surface by overcorrection more than the skew correction amount that makes one end of the medium be parallel to the reference surface.
